(19) United States
(12) Patent Application Publication
(10) Pub. No.: US 2008/0002878 A1
(43) Pub. Date: Jan. 3, 2008

(54) Method For Fast Stereo Matching Of Images

(76) Inventor: Somasundaram Meiyappan, The Comtech (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/426,940

(22) Filed: Jun. 28, 2006

(51) Int. Cl. G06K 9/00; G06K 9/32

(52) U.S. Cl. 382/154; 382/294

(57) ABSTRACT

A method for high-speed stereo matching of digital images is disclosed. Initially, two digital images of a scene are received as input. Each image is then divided into segments using a three by three (3×3) grid. Next, multiple search zones are defined for each image. The search zones are defined such that each search zone overlaps an edge of the central segment of the grid. Each search zone in one image is correlated with the corresponding search zone at the corresponding location in the other image using normalized cross correlation. In one embodiment, the median correlation value is selected from the list of correlation values obtained as output of correlation, and subsequently, the x-shift and y-shift values that correspond to the median correlation value are retrieved. In another embodiment, a list of x-shift values and y-shift values are obtained as output of correlation. The median x-shift value and the median y-shift value are then selected from the list.

### BACKGROUND

Stereoscopic photography is the art of taking two pictures of the same subject from two slightly different view points, e.g. left and right eye views, and displaying them in such a way that each human eye sees only one of the images. The illusion of depth in a photograph or other 2-dimensional image is created by presenting a slightly different image to each eye. Stereoscopic photography involves two phases: capturing and presenting the image. One approach for capturing right and left images of the same scene is to use two identical cameras arranged in parallel or a specialized two-lens camera. To compose a stereoscopic image, only the common region that is visible in both the right and left images should be used. The image portions outside of the common region should be cropped and removed. The task of identifying the common region can be manually done by the user but it is troublesome and very time-consuming. There are available digital image processing programs for automatically creating stereo images, e.g. Cosima and Stereophoto Maker, which require the captured images to be in digital format. The cropping is done automatically by the programs. However, these programs utilize stereo matching techniques that require a very long run-time for computation, e.g. 6-10 minutes.

There exists the need for a stereo matching method for producing stereoscopic images that can significantly reduce the processing time.

### SUMMARY

The present invention provides a method for high-speed stereo matching of digital images in order to produce stereoscopic images for viewing. Initially, two digital images of a scene are received as input. Each image is then divided into segments using a three by three (3×3) grid. Next, multiple search zones are defined for each image. The search zones are defined such that each search zone overlaps an edge of the central segment of the grid. Each search zone in one image is correlated with the corresponding search zone at the corresponding location in the other image using normalized cross correlation. In one embodiment, the median correlation value is selected from the list of correlation values obtained as output of correlation. Subsequently, the x-shift and y-shift values that correspond to the median correlation value are retrieved. In another embodiment, a list of x-shift values and y-shift values are obtained as output of correlation. The median x-shift value and the median y-shift value are selected from the list.

The objects, features and advantages of the present invention will become apparent from the detailed description when read in conjunction with the drawings.

### BRIEF DESCRIPTION OF THE DRAWINGS

FIG. 1 is a top view showing camera geometry for capturing two images of a scene using two cameras.

FIG. 2 is a side view showing a vertical misalignment between two cameras.

FIG. 3 is a flow diagram representing a stereo matching method according to one embodiment of the present invention.

FIG. 4 illustrates how an image is segmented in the stereo matching method of FIG. 3.

FIG. 5 shows three exemplary search zones that may be used in the stereo matching method of FIG. 3.

FIG. 6 shows five exemplary search zones that may be used in the stereo matching method of FIG. 3.

FIG. 7A illustrates a manner of moving a template over a search zone during correlation according to an embodiment of the present invention.

FIG. 7B illustrates a conventional, unidirectional manner of implementing cross-correlation.

FIG. 8 is a flow diagram representing a stereo matching method according to another embodiment of the present invention.

FIG. 9 is a flow diagram representing a method for finding a correlation value that includes pruning search space according an embodiment of the present invention.

FIG. 10 is a flow diagram representing a stereo matching method according to another embodiment of the present invention.

FIG. 11 is a flow diagram representing a method for generating a stereoscopic image from photographs in accordance with an embodiment of the present invention.

### DETAILED DESCRIPTION

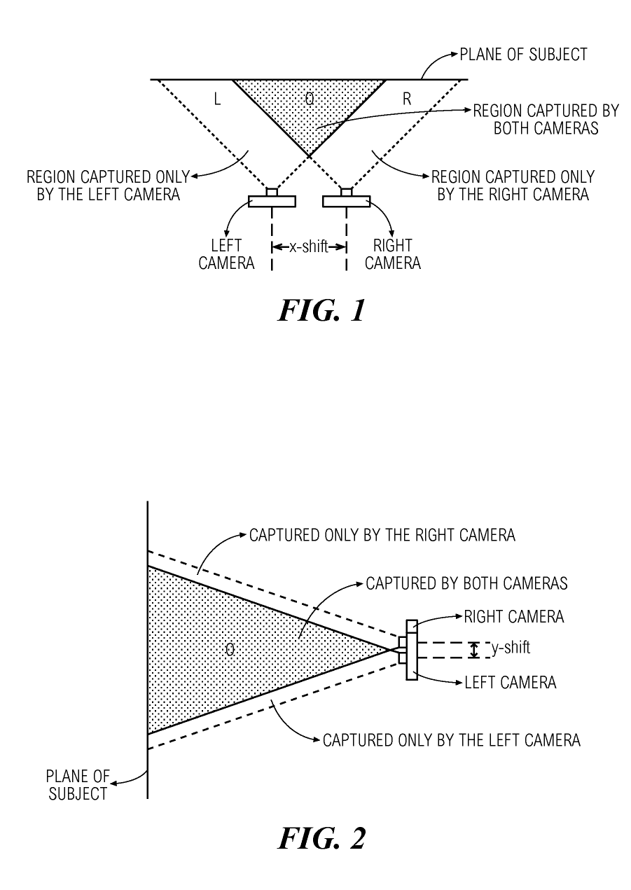

Stereo image processing has been used to process multiple images showing different views of a scene to identify common image features across different images. Stereo matching of digital images is conventionally used to provide three-dimensional (3-D) information. According to one embodiment of the present invention, stereo matching is used to process two images from two different views of the same scene. To capture such images, two cameras may be used. FIG. 1 is a top view of the camera geometry for capturing the images. The region L is captured only by the left camera and region R is captured only by the right camera. The region O is the common region (or overlapping region) captured by both cameras. The horizontal separation between the two cameras is called x-shift. When there is a vertical displacement between the two cameras as shown in the side view of FIG. 2, this displacement is called y-shift. The common region O can be identified by finding the x-shift and y-shift. As an alternative image capturing method, a single camera is moved from left to right or vice versa to capture two images. In such case, the L, R and O regions are created by two different positions of the camera.

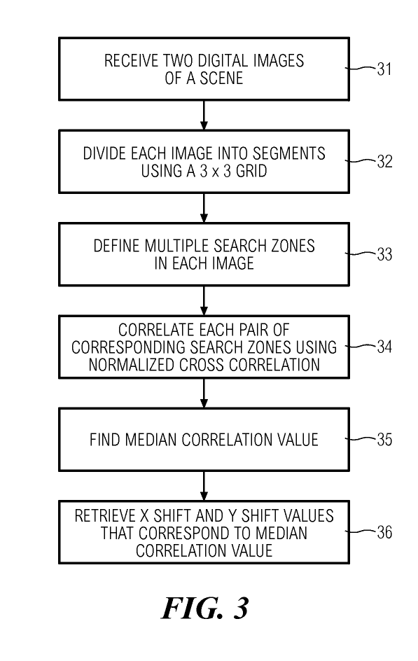

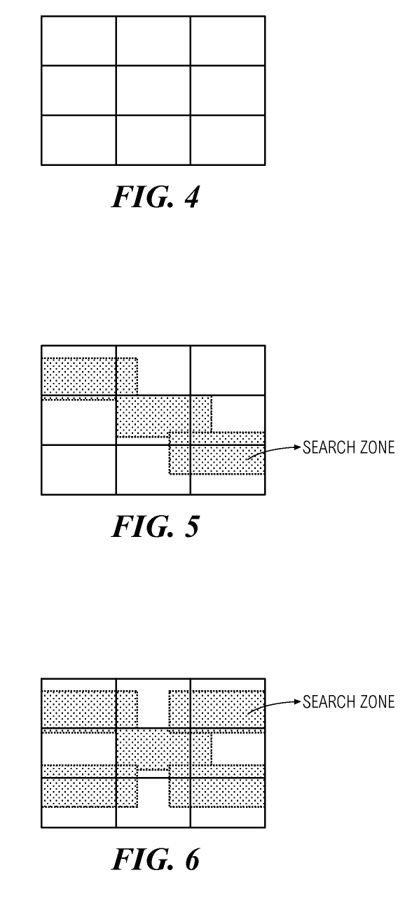

FIG. 3 is a flow diagram representing a stereo matching method according to one embodiment. Initially, two digital images of a scene are received at step 31. At step 32, each image is divided into segments using a 3×3 grid, i.e. the image is divided into thirds both horizontally and vertically. This segmentation is illustrated in FIG. 4. Referring to FIG. 3, multiple search zones are defined for each image at step 33. The search zones are defined such that each search zone overlaps an edge of the central segment of the grid. As illustration, three exemplary search zones are shown in FIG. 5. To increase accuracy, five search zones may be defined as shown in FIG. 6. In this case, all four corners of the central segment are included in the search zones. However, to reduce processing time, it is sufficient to define three search zones. Referring to FIG. 3, at step 34, each search zone in one image is correlated with the corresponding search zone at the corresponding location in the other image using normalized cross correlation (NCC).

Normalized cross correlation (NCC) is a measure of how well two images match each other. During correlation using NCC, a template, which is a match window taken from a first image, is moved over a second image. For the stereo matching method of FIG. 3, normalized cross correlation C(u,v) may be represented by the following equation:

$$C ( u , v ) = \frac{{\sum }_{y} {\sum }_{x} [ ( {I}_{u , v} ( x , y ) - \overline{{I}_{u , v}} ) ( T ( x , y ) - \overline{T} ) ]}{\sqrt{{\sum }_{y} {\sum }_{x} {( {I}_{u , v} ( x , y ) - \overline{{I}_{u , v}} )}^{2} {\sum }_{y} {\sum }_{x} {( T ( x , y ) - \overline{T} )}^{2}}}$$

where T represents the template that moves over the search space I, and I_{u,v} is a window within the search space I that corresponds to T. T̅ is the average of all values in the two dimensional array T. C(u,v) indicates how well T and I_{u,v} match each other when T is translated by u in x direction and v in y direction with respect to I. T, I and I_{u,v} contain the luminance information of every pixel within the image area that they represent. The normalized cross correlation results in a triplet—Cₘₐₓ, Xₘ, Yₘ, where Xₘ, Yₘ indicate the amount of translational shift required for the image contained in the template to match the image contained in the search space I, such that the correlation score C(u=Xₘ,v=Yₘ)=Cₘₐₓ. Cₘₐₓ is the maximum of all the correlation values obtained from using the above formula for all valid values of u and v in a given search-space and template pair.

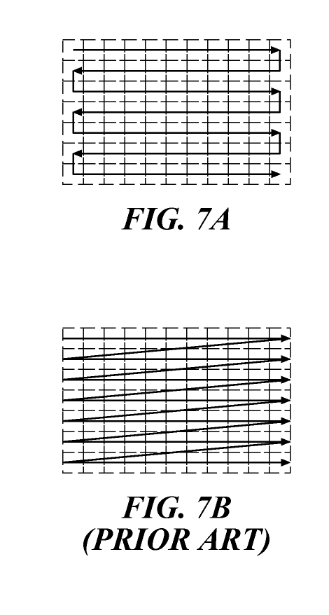

Consider a pair of left and right images having corresponding search spaces. Assume that a template is extracted from a search space in the right image. During correlation at step 34 in FIG. 3, the template from the search space on the right image is shifted by one pixel at a time, horizontally back and forth in the x direction and progressively downward in the y direction, over the corresponding search space in the left image. This back and forth movement is illustrated in FIG. 7A. This manner of moving the template is different from the conventional manner of implementing cross-correlation, which is unidirectional as illustrated in FIG. 7B. By moving the template over the search zone as illustrated in FIG. 7A, the NCC computation time is decreased significantly because the number of computations for various parts of the NCC formula can be reduced. Furthermore, the cache performance is improved when this correlation method is implemented in either software or hardware. It should be understood that using two or more templates from the right image is possible. However, using multiple templates would increase the computation time but the accuracy of the matching process is not necessarily improved.

Referring again to FIG. 3, a set of correlation values is obtained for all of the search zones as the result of the correlation in step 34. From the correlation values obtained, the method then proceeds to find the median correlation value at step 35. At step 36, the x-shift and y-shift values that correspond to the median correlation value are retrieved. The stereo matching method is finished at this point. The x-shift and y-shift indicate the amount of horizontal shift and vertical shift, respectively, for aligning one image relative to the other such that the overlapping region may be obtained.

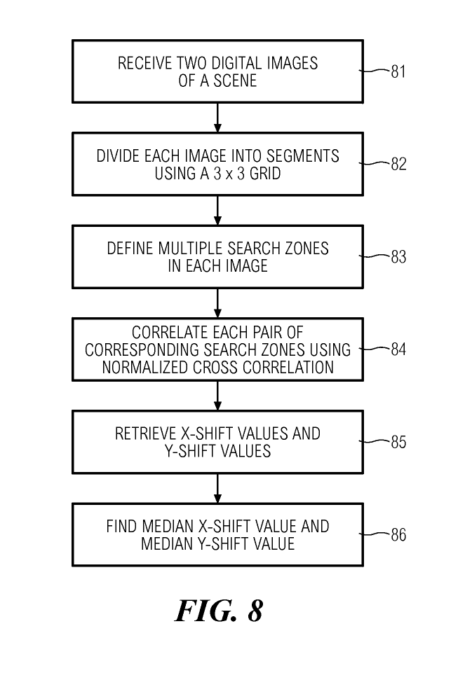

FIG. 8 illustrates another embodiment that is a variation of the method shown in FIG. 3. Steps 81-84 in FIG. 8 are substantially the same as steps 31-34 in FIG. 3. At step 85, the x-shift and y-shift values are retrieved after correlation is performed for each pair of corresponding search zones. After correlation has been performed for all of the search zones, a list of x-shift and y-shift values is obtained. At step 86, the median x-shift value and the median y-shift value are found from the list of x-shift and y-shift values.

Each search zone discussed above may be further pruned during correlation to further increase the speed of computing NCC values. In general terms, the pruning technique of the present invention involves performing template matching on a sample of smaller regions with predetermined coordinate positions within the search zone. The search zone is then reduced vertically around the y coordinate position that yields the maximum NCC value. Furthermore, the minimum and maximum x-shift values are retrieved from the list of x-shift values that are recorded as output during the matching computations for the smaller regions. The search zone is further reduced horizontally using these minimum and maximum x-shift values. Template matching is then repeated on the pruned search zone. As such, template matching is not carried out on each and every x-y coordinate position within the search zone. Instead, template matching is carried out by a more streamlined method whereby the number of matching computations is reduced.

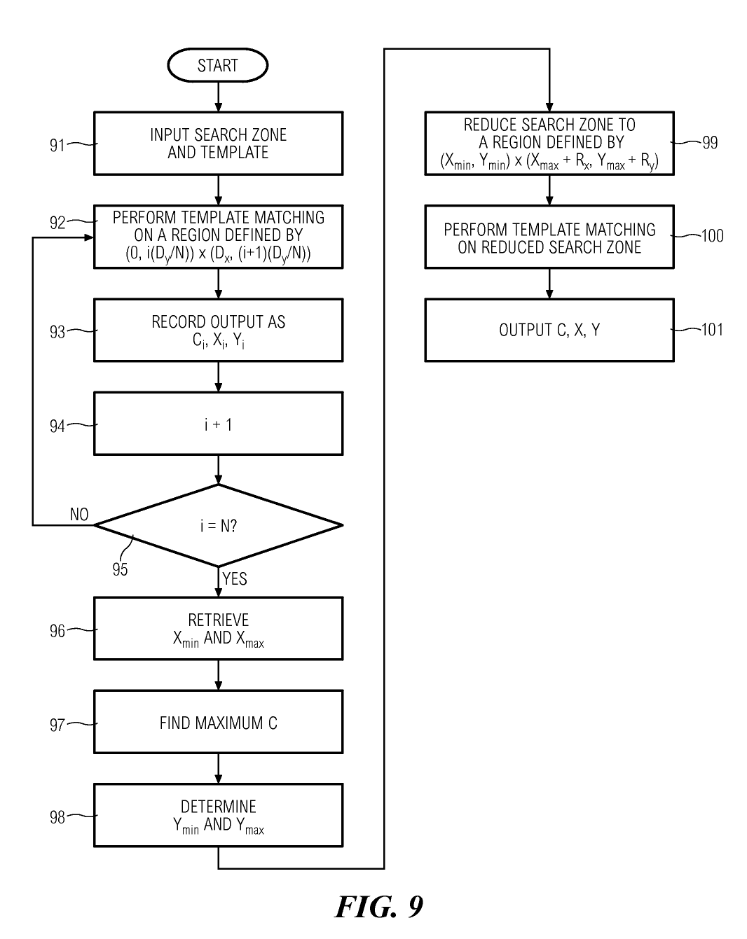

FIG. 9 is a flow diagram of a method for finding the correlation value that includes pruning the search zone. At step 91, a search zone of one image and a corresponding smaller template, T, from the other image are received as input. Let Lₓ and L_{y} denote the width and height of the search zone, respectively, and Rₓ and R_{y} denote the width and height of the template, respectively. At step 92, template matching is performed by moving the template over a smaller region within the search zone defined by (0, i(D_{y}/N))×(Dₓ, (i+1)(D_{y}/N)), where Dₓ=Lₓ−Rₓ and D_{y}=L_{y}−R_{y}, and i denotes an index variable that varies from 0 to N−1, with N being greater than or equal to 2. While smaller values of N may be used to improve speed, the accuracy of the shift values computed is decreased. On the other hand, larger values of N, while improving accuracy, result in an increase in computation time. Suitable values for N include 3, 4 and 5. At step 93, the output of correlation is recorded as Cᵢ, Xᵢ and Yᵢ. At step 94, i is increased by 1. At step 95, the method determines whether i is equal to N. If the answer is no, the method returns to step 92. Thus, the template matching step 92 is repeated N times with the value of i being increased by 1 each time. After template matching has been performed for N times, i.e., the answer at step 95 is yes, the method proceeds to step 96 where the minimum X (Xₘᵢₙ) and the maximum X (Xₘₐₓ) are retrieved from the list of recorded values of X₀, X₁, . . . X_{N-1}. At step 97, the maximum C is retrieved from the list of recorded values of C₀, C₁, . . . C_{N-1}, and the Y value corresponding therewith is recorded. Next, at step 98, Yₘᵢₙ and Yₘₐₓ are determined such that they are bounded by the following expressions:

max(Y_{C}−D_{y}/N,0)≦Yₘᵢₙ≦Y_{C}

Y_{C}≦Yₘₐₓ≦min(Y_{C}+D_{y}/N,D_{y})

where Y_{C} is the Y value that corresponds to the maximum C. At step 99, the original search zone is reduced to a region defined by (Xₘᵢₙ, Yₘᵢₙ)×(Xₘₐₓ+Rₓ, Yₘₐₓ+R_{y}). After the search zone has been reduced, the method proceeds to step 100 where template matching is performed on the reduced search zone. At step 101, the final C, X and Y values are provided as output.

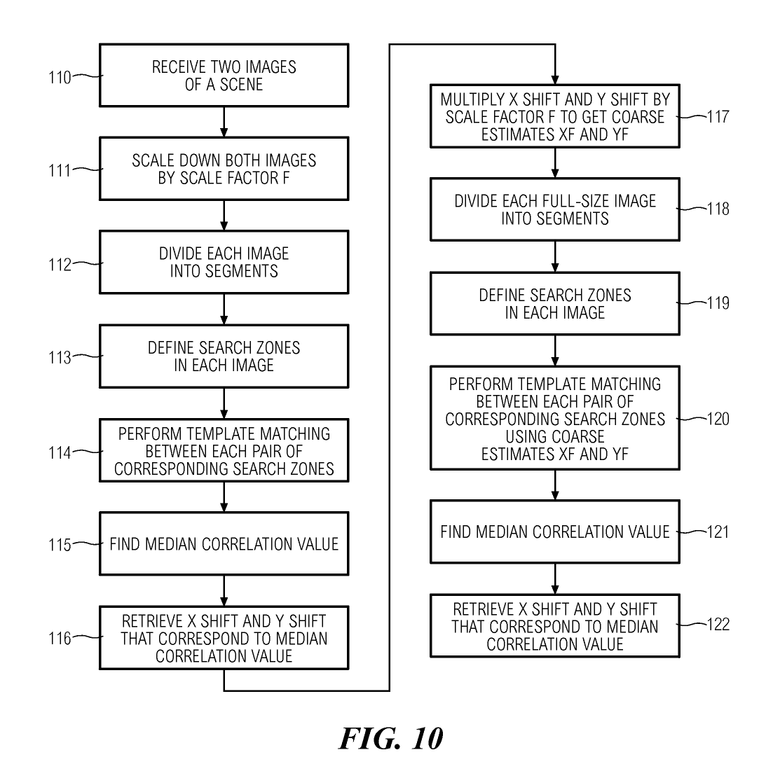

FIG. 10 is a flow diagram representing a stereo matching method according to another embodiment. At step 110, two images of a scene (in digital format) are received as input. Both images are scaled down by a scale factor F at step 111. At step 112, each scaled down image is divided into nine segments using a 3×3 grid. At step 113, a plurality of search zones is defined in each image such that each search zone overlaps an edge of the central segment of the grid. At step 114, template matching is performed between each pair of corresponding search zones, thereby providing as output a set of correlation values and corresponding x-shift and y-shift values. At step 115, the median correlation value is found. At step 116, the x-shift and y-shift values that correspond to the median correlation are retrieved. As such, steps 110-116 are similar to steps 32-36 in FIG. 3. At step 117, the x-shift and y-shift values are multiplied by the scale factor F to get coarse estimates (XF, YF) of the x-shift and y-shift values for the given image pair. After the coarse estimates are obtained, the method proceeds to step 119 where each of the original full-size images is divided into nine segments using a 3×3 grid. Multiple search zones are defined in each image at step 120 as in step 113. At step 120, template matching is performed between each pair of corresponding search zones using the coarse estimates XF and YF to narrow the matching process. This time, template matching is performed on a smaller search region within each search zone of one full-size image, wherein the smaller search region is defined by (XF−F, XF+F) in the x axis and (YF−F, YF+F) in the y axis. For example, template matching can be done by moving a template from a search zone in the right image over the corresponding search zone in the left image such that the template is shifted along the x axis within the range of XF−F to XF+F, and along the y axis within the range of YF−F to YF+F. At step 121, the median correlation value is selected from the correlation values obtained for all the search zones. This process of template matching on smaller search regions within the larger full-size image helps to reduce the computation time. Subsequently, at step 122, the x-shift and y-shift values that correspond to the median correlation value are retrieved. Steps 110-117 may be considered as the coarse estimation part of the stereo matching method, and steps 118-122 may be considered as the fine-tuning part. The coarse estimation part processes the scaled down image, and the fine-tuning part processes the full-size image.

As an alternative to steps 115 and 116 in FIG. 10, a list of x-shift and y-shift values is retrieved as output of step 114, and then the median x-shift value and the median y-shift value are retrieved from this list. Similarly for steps 121 and 122, instead of finding the median correlation value to retrieve x-shift and y-shift values, a list of x-shift and y-shift values is retrieved as output of step 120, and then the median x-shift value and the median y-shift value are retrieved from this list.

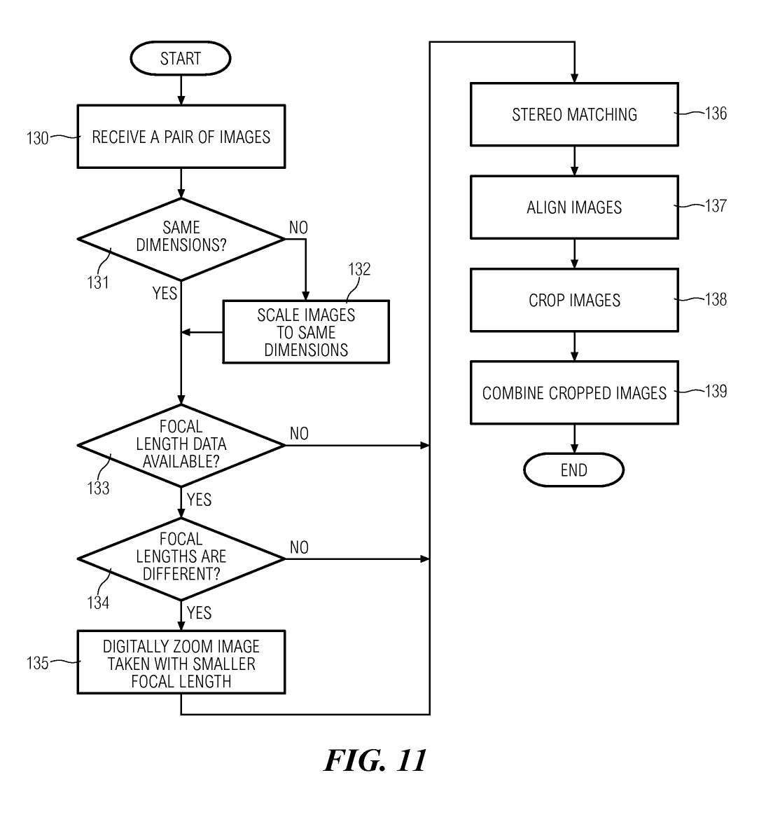

One application of the stereo matching method discussed above is in stereo photography. The initial stage of stereo photography is capturing a stereo pair of images. To produce a stereo pair of images, photographs of a scene are taken at slightly different views. For the best result, the stereo pair of images used for creating a stereoscopic image should be taken at the same lens focal length. However, many cameras are provided with zoom lens, whereby images may be captured at different focal lengths. FIG. 11 is a flow diagram representing a method for generating stereoscopic images from photographs in accordance with an embodiment of the present invention, wherein compensation is provided for images captured using different lens focal lengths when such data is known.

Referring to FIG. 11, a stereo pair of images is received as input at step 130. The images are received in digital format. Thus, if the images are photographs taken by film-based cameras then the images have to be converted into digital images. At step 131, it is determined whether the images have the same dimensions. If the answer is no, the method proceeds to step 132 where the images are scaled to the same dimensions before proceeding to step 133. If the answer at step 131 is yes, then the method proceeds directly to step 133. At step 133, it is determined whether lens focal length data is available, i.e. provided with the images. In many commercially available digital cameras, the lens focal length data is automatically recorded by the camera for each captured image in the form of tags such as EXIF tags. If the answer at step 133 is no, then the method proceeds directly to step 136. If the answer at step 133 is yes, then the method proceeds to step 134 where it is determined whether the lens focal lengths are different. If the answer at step 134 is yes, then the method proceeds to step 135 where the image taken with the smaller focal length is digitally zoomed and the other image is scaled down, as necessary, so that the final images have same dimensions. The process then proceeds to step 136. If the answer at step 134 is no, then the process proceeds directly to step 136. At step 136, stereo matching of the images are performed according to one of the embodiments describe above. As a result of stereo matching, optimum x-shift and y-shift values are determined. At step 137, the images are aligned by shifting one (e.g. right) image relative to the other (e.g. left) image horizontally by x-shift value and vertically by y-shift value, thereby resulting in overlapping the common portions of the image pair. At step 138, the images are then cropped to remove portions that are not overlapped. The cropped, overlapping images are then combined to form a stereoscopic image at step 139.

The cropped images are combined in a manner suitable for 3-D viewing. There are several ways to display stereoscopic images for viewing. Two common display techniques are side-by-side and anaglyph. Anaglyph images are produced using colors to combine or encode a stereo pair of images into a single image. These images may then be viewed with “3-D glasses,” which have color filters arranged such that the color filter that corresponds to each eye decodes the anaglyph to obtain the respective perspective of the scene. The human brain constructs a 3-D image from the two perspective views of the scene.

The above methods of the present invention may be embedded in a computer program product, which has a computer readable medium containing programming instructions for carrying out the steps in the above embodiments.

Aside from stereo photography, the stereo matching method of the present invention also has applications in 3-D cinematography and videography where stereoscopic images are created.

Although specific embodiments of the present invention have been disclosed, it will be understood by those skilled in the art that various modifications may be made to the embodiments without departure from the scope of the invention as defined by the appended claims.

What is claimed is:

1. A method for stereo matching images comprising:
receiving two digital images of a scene as input;
dividing each image into segments using a three by three (3×3) grid;
defining multiple search zones for each image, wherein the search zones are defined such that each search zone overlaps an edge of the central segment of the grid;
correlating each search zone in one image with a corresponding search zone at the corresponding location in the other image using normalized cross correlation, thereby obtaining as output a set of correlation values;
selecting the median correlation value from said set of correlation values; and
retrieving x-shift and y-shift values that correspond to the median correlation value.

2. A method for stereo matching images comprising:
receiving two digital images of a scene as input;
dividing each image into segments using a three by three (3×3) grid;
defining multiple search zones for each image, wherein the search zones are defined such that each search zone overlaps an edge of the central segment of the grid;
correlating each search zone in one image with a corresponding search zone at the corresponding location in the other image using normalized cross correlation;
retrieving a list of x-shift values and y-shift values as output from correlating all pairs of corresponding search zones; and
selecting a median x-shift value and a median y-shift value from said list.

3. The method of claim 1, wherein correlating each search zone in one image with a corresponding search zone comprises:
defining a template in one search zone; and
shifting said template over the corresponding search zone to perform template matching, wherein said template is shifted horizontally back and forth and progressively downward.

4. The method of claim 2, wherein correlating each search zone in one image with a corresponding search zone comprises:
defining a template in one search zone; and
shifting said template over the corresponding search zone to perform template matching, wherein said template is shifted horizontally back and forth and progressively downward.

5. The method of claim 1, wherein correlating each search zone in one image with a corresponding search zone in the other image comprises:
defining a template in one search zone;
performing template matching on a sample of smaller regions within the corresponding search zone;
obtaining an output list of correlation values, x shift values, and y-shift values as output of template matching;
retrieving the maximum correlation value from said output list and the y-shift value corresponding to said maximum correlation value;
pruning the corresponding search zone vertically around said y-shift value that corresponds to said maximum correlation value;
retrieving minimum and maximum x-shift values from said output list;
pruning the corresponding search zone horizontally based on the minimum and maximum x-shift values; and
performing template matching on the pruned search zone.

6. A method for stereo matching images comprising:
receiving two full-size images of a scene as input;
scaling down both images by a scale factor F;
dividing each scaled-down image into segments using a three by three (3×3) grid;
defining multiple search zones in each scaled-down image, wherein the search zones are defined such that each search zone overlaps an edge of the central segment of the grid;
perform template matching between each pair of corresponding search zones, thereby obtaining as output a first set of correlation values;
selecting the median correlation value from said first set of correlation values;
retrieving x-shift value and y-shift value that correspond to the median correlation value selected from said first set of correlation values;
multiplying the retrieved x-shift value and y-shift value by the scale factor F to obtain coarse estimates;
dividing each full-size image into segments using a three by three (3×3) grid;
defining multiple search zones in each full-size image, wherein the search zones are defined such that each search zone overlaps an edge of the central segment of the grid;
defining a smaller search region within each search zone of one full-size image based on the coarse estimates;
defining templates in the other full-size image that correspond to the search zones of said one full-size image;
template matching on the smaller search regions;
obtaining as output of template matching a second set of correlation values;
selecting the median correlation value from said second set of correlation values; and
retrieving x-shift value and y-shift value that correspond to the median correlation value selected from said second set of correlation values.

7. A method for generating a stereoscopic image comprising:
receiving two digital images of a scene;
stereo matching the images to obtain x-shift value and y-shift value;
aligning the images using said x-shift value and y-shift value, thereby resulting in overlapping the common portions of the images;
cropping the images to remove portions that do not overlap; and
combining the cropped images for stereoscopic viewing,
wherein stereo matching the images comprises:
(a) dividing each image into segments using a three by three (3×3) grid;
(b) defining multiple search zones for each image, wherein the search zones are defined such that each search zone overlaps an edge of the central segment of the grid;
(c) correlating each search zone in one image with a corresponding search zone at the corresponding location in the other image using normalized cross correlation, thereby obtaining as output a set of correlation values for all pairs of corresponding search zones;
(d) selecting the median correlation value from said set of correlation values; and
(e) retrieving x-shift and y-shift values that correspond to the median correlation value.

8. A method for generating a stereoscopic image comprising:
receiving two digital images of a scene;
stereo matching the images to obtain x-shift value and y-shift value;
aligning the images using said x-shift value and y-shift value, thereby resulting in overlapping common portions of the images;
cropping the images to remove portions that do not overlap; and
combining the cropped images for stereoscopic viewing,
wherein stereo matching the images comprises:
(a) dividing each image into segments using a three by three (3×3) grid;
(b) defining multiple search zones for each image, wherein the search zones are defined such that each search zone overlaps an edge of the central segment of the grid;
(c) correlating each search zone in one image with a corresponding search zone at the corresponding location in the other image using normalized cross correlation;
(d) retrieving a list of x-shift values and y-shift values as output from correlating all pairs of corresponding search zones; and
(e) selecting a median x-shift value and a median y-shift value from said list.

9. The method of claim 7 further comprising:
scaling the images to the same dimensions if the images received are not of the same dimensions.

10. The method of claim 7 further comprising:
prior to stereo matching, determining whether the images were taken at different lens focal lengths; and
digitally zoom one image to match the other image if it is determined that the images were taken using different lens focal lengths.

11. The method of claim 8 further comprising:
scaling the images to the same dimensions if the images received are not of the same dimensions.

12. The method of claim 8 further comprising:
prior to stereo matching, determining whether the images were taken at different lens focal lengths; and
digitally zoom one image to match the other image if it is determined that the images were taken using different lens focal lengths.

13. A computer readable medium comprising a program stored therein, said program comprising instructions for carrying out the method of claim 1.

14. A computer readable medium comprising a program stored therein, said program comprising instructions for carrying out the method of claim 2.

15. A computer readable medium comprising a program stored therein, said program comprising instructions for carrying out the method of claim 6.

16. A computer readable medium comprising a program stored therein, said program comprising instructions for carrying out the method of claim 7.

17. A computer readable medium comprising a program stored therein, said program comprising instructions for carrying out the method of claim 8.
